(19) United States
(12) Patent Application Publication
(10) Pub. No.: US 2006/0245096 A1
(43) Pub. Date: Nov. 2, 2006

(54) Application framework phasing model

(75) Inventors: Arshad F. Ahmad, Bellevue, WA (US); Brad M. Olenick, Redmond, WA (US); Clemens A. Szyperski, Redmond, WA (US); David G. Hunt, Woodinville, WA (US); Gregory L. Hughes, Bellevue, WA (US); Simeon Cran, Redmond, WA (US); William A. Manis, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/360,455

(22) Filed: Feb. 23, 2006

Related U.S. Application Data
(60) Provisional application No. 60/676,137, filed on Apr. 29, 2005.
(60) Provisional application No. 60/703,220, filed on Jul. 28, 2005.

(51) Int. Cl. G11B 5/00

(52) U.S. Cl. 360/1

(57) ABSTRACT

The present invention comprises phasing systems and methods for software systems. In embodiments of the present invention, the phasing system comprises a multi-tiered phasing space where operations within the software system are constrained to a phase or a sub-phase. The operations execute only in the specified phase. Thus, operations that could yield improper results in large and complex software systems do not execute simultaneously but follow a certain order. The present invention also provides a data structure to introduce the phase constraints as software attributes into the software code.

### CROSS-REFERENCE TO RELATED APPLICATIONS

This patent application claims priority to U.S. Patent Application Ser. No. 60/676,137 filed Apr. 29, 2005 and entitled “Application Description Language,” and U.S. Patent Application Ser. No. 60/703,220 filed Jul. 28, 2005 and entitled “Markup Language Based Application Framework with Application Description Language, Concurrency Domains, Application Framework Phasing Models, and Application Framework Transaction Transforms”, the disclosures of which are expressly incorporated herein, in their entirety, by reference.

This patent application is also related to and filed concurrently with U.S. patent application Ser. No. ______, entitled “Multithreading with Concurrency Domains,” bearing attorney docket number 14917.0258USU1/MS310186.01; U.S. patent application Ser. No. ______, entitled “XML Application Framework,” bearing attorney docket number 14917.0258USU3/MS311586.01; U.S. patent application Ser. No. ______, entitled “Application Description Language,” bearing attorney docket number 14917.0258USU4/MS309853.01; and U.S. patent application Ser. No. ______, entitled “Transaction Transforms,” bearing attorney docket number 14917.0258USU5/MS311262.01; U.S. patent application Ser. No. ______, entitled “XML Application Framework”, bearing attorney docket number 14917.0258USU6/MS316537.01; U.S. patent application Ser. No. ______, entitled “XML Application Framework”, bearing attorney docket number 14917.0258USU7/MS316538.01; U.S. patent application Ser. No. ______, entitled “XML Application Framework”, bearing attorney docket number 14917.0258USU8/MS316539.01; which are assigned to the same assignee as the present application and expressly incorporated herein, in their entirety, by reference.

### BACKGROUND

Generally, software systems complete operations by executing processes within the computer. Often, a single process may comprise several simple tasks or methods. To complete the process correctly, the simple methods must be completed in a certain order because the result from one simple method may be the input to another simple method. If the methods try to execute before receiving the proper input or if a method provides a result that is not timely, then the overall process may fail. Thus, the ordering of the execution of the methods within a software system is very important.

For software developers, the ordering of methods becomes a major concern when developing software code. Generally, methods in a software system make calls to other methods so that the other methods can execute and provide some operation. The software developer must pay heed to the ordering of calls to methods and try to write the code to operate in any situation regardless of the order of the calls. Unfortunately, developing complex code that is flexible enough to operate in any condition is extremely difficult. When software applications grow in size and complexity, the explosion of possible call orderings makes it very difficult to implement correctly the ordering of calls to methods. The burden on the software developers can become significant when there are multiple methods calling several different methods where the results returned must arrive in a certain order for the process to execute properly. Likewise, it is difficult for software developers to test flexible code that has methods making various calls in varying operating scenarios.

It is with respect to these considerations and others that the present invention has been made.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present invention provides for constraining the execution of software methods throughout an entire computer system. Generally, the present invention provides a multi-tiered phasing model -that constrains the execution of software methods into two or more phases, each phase possibly having two or more sub-phases. Phases are operating states that partition the methods of a software system. All methods in a partition are constrained to only execute during a particular phase. A phase domain is created when a set of software components agree on a common phasing in a phase space. A phase space determines the valid sequences of phases. In embodiments of the present invention, a phase space is a finite directed graph that determines valid phases and valid phase transitions for the software components.

In embodiments of the present invention, the software components are subject to a phase constraint. A phase constraint is a static constraint that limits the phases valid in a certain software program context. A phase constraint can be applied to a software program section, ensuring that whenever that software program section is executed the executing thread will be in a phase honoring the constraint. To apply a phase constraint, a software component may include a data structure that forms a phase constraint attribute. The phase constraint attribute may be part of the runtime metadata of the software component.

In embodiments of the present invention, a computer-readable medium comprises a plurality of components occupying a first phase domain. In some embodiments, a first subset of software components occupies a first sub-phase domain and a second subset of software components occupies a second sub-phase domain. In embodiments of the present invention, sub-phases are phases that are grouped under a parent phase.

In one embodiment, the present invention provides a method for partitioning the execution of a plurality of methods into phases within a software system. The method first transitions to a first phase possibly having two or more sub-phases. The execution of a first set of methods is constrained to a first phase. Then, the computer system transitions to one or more other phases, where the execution of one or more other sets of methods is constrained to one or more other phases. Finally, the computer system transitions to one or more other phases.

In embodiments of the present invention, a software system is also provided. The software system comprises a master director component that controls a set of phases for the entire software system. A director is a software construct that controls the transition of phases within a phase space. In some embodiments, one or more sub-directors are registered with the master director and control one or more sets of sub-phases. One or more components are registered with the one or more directors and are constrained to execute methods only during the one or more phases.

The invention may be implemented as a computer process, a computing system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its improvements can be obtained by reference to the accompanying drawings, which are briefly summarized below, to the following detailed description of embodiments of the invention, and to the appended claims.

### BRIEF DESCRIPTION OF THE DRAWINGS

FIG. 1 is an embodiment of multi-tiered phasing model operable in a computer environment to order the execution of software methods according to the present invention.

FIG. 2 is a functional diagram illustrating a computing environment and a computing device that operate the phasing model according to the present invention.

FIG. 3 is an embodiment of a modular software system having software components for ordering the execution of software methods in a phase model according to the present invention.

FIG. 4 is an embodiment of a first or top-level phase model or space operating over an entire computer system to order the execution of any software method within the system according to the present invention.

FIG. 5 is an embodiment of a sub-phase spaces operable during one or more of the phases of a master phase space, such as the master phase space of FIG. 4, which orders the retrieval and writing of data according to the present invention.

FIG. 6A and FIG. 6B are embodiments of sub-phase spaces operable during one or more of the phases of a master phase space, such as the master phase space of FIG. 4, which orders the configuration and operation of a plug and play system according to the present invention.

FIG. 7 shows an embodiment of a data structure or language attribution containing a phase constraint attribute that declares a constraint on the execution of a software method to a certain phase according to the present invention.

FIG. 8A and FIG. 8B shows an embodiment of a method for phasing the operations of a computer system according to the present invention.

FIG. 9 is an exemplary computer system operating to provide and store user contact information operating in a phased domain according to the present invention.

### DETAILED DESCRIPTION

The present invention will now be described more fully with reference to the accompanying drawings, in which exemplary embodiments of the invention are shown. The invention may, however, be embodied in many different forms and should not be construed as limited to the embodiments set forth herein. Rather, these embodiments are provided so that the disclosure is thorough and complete and will fully convey the scope of the invention to those skilled in the art.

Generally, phasing constrains the execution of software methods within a computer system by subjecting the software components to a multi-tiered phasing model. A software component can be a class, an object, a method, or other software code construct that is within a computer system. A phase is an operating state that is simultaneously and collectively shared by a set of software components. The computer system executes a top-level phasing model, also referred to as a master phasing model, with one or more sub-phases occurring during one or more of the phases of the master phasing model. The operations within the computer system are constrained to a set of phases or sub-phases.

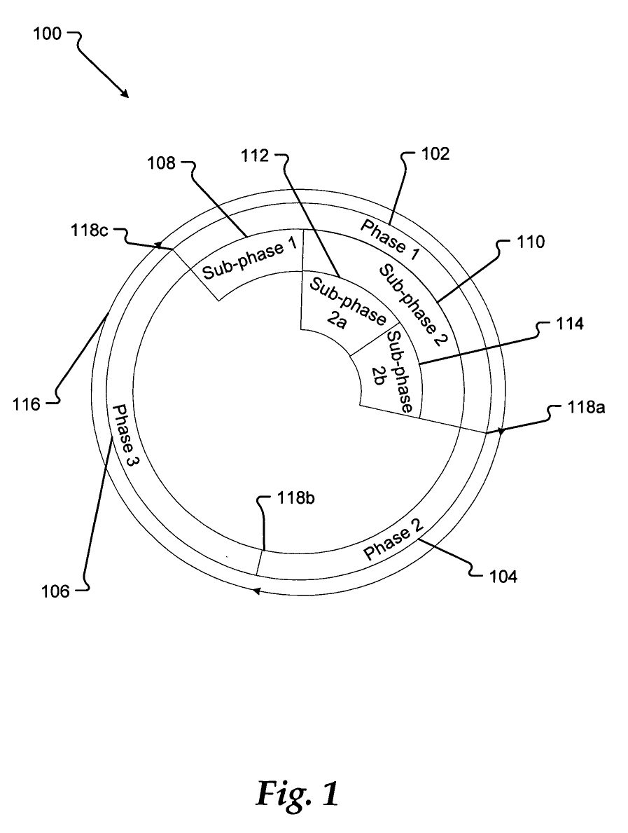

An exemplary embodiment of the multi-tiered phasing model 100 is shown in FIG. 1. The multi-tiered phasing model has a first or a master phase model comprising three phases 102, 104, and 106. The master phases occur in an order delineated by the arrows 116. Two sub-phases, sub-phase 1 108 and sub-phase 2 110, occur during phase 1 102. In addition, two further sub-phases, sub-phase 2a and sub-phase 2b, occur during sub-phase 2. Thus, the phasing model 100 presents a multi-tiered set of phases with sub-phases occurring during other phases or sub-phases. Hereinafter, any discussion of a phase may also apply to a sub-phase.

Each software component is constrained to operate within a certain phase. A constraint is placed upon each of the software methods to execute or to be called only during the phases to which the software method is constrained. Software methods that can create conflicts or contradictory results are constrained to different phases, where the software methods cannot be legally called from the current phase. As such, each software method is executed in a known fashion without conflict between the methods that accomplish contradictory tasks. All methods execute under a particular phase constraint such that the software system is known to be in a state compatible with the present phase constraint.

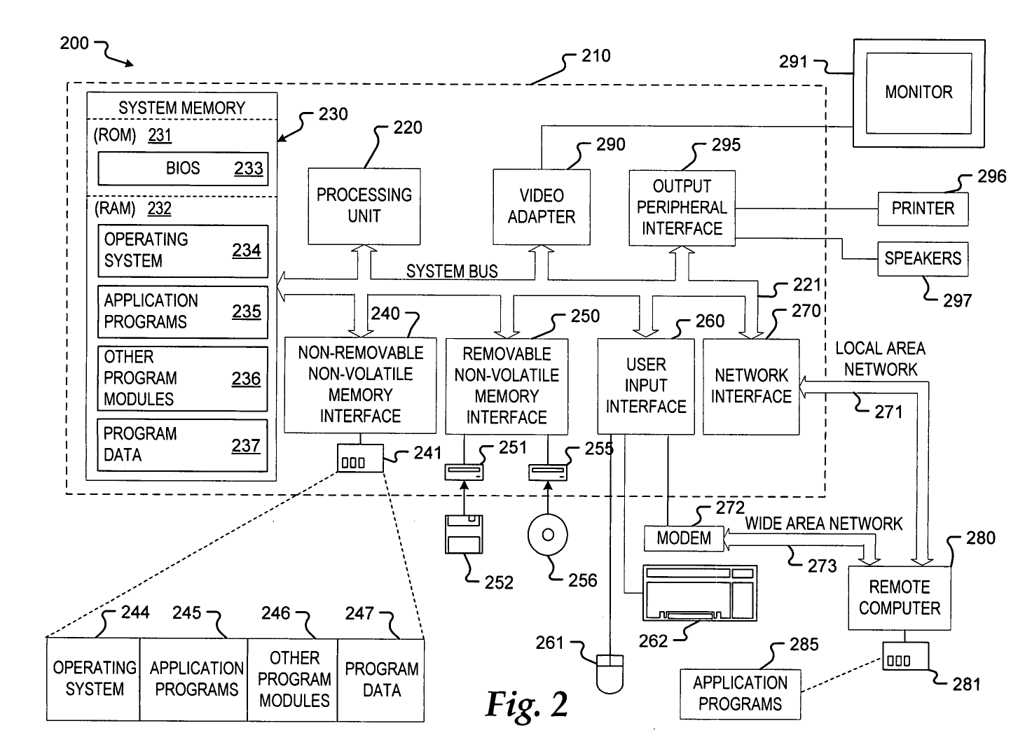

An example of a suitable computing system environment 200 on which the invention may be implemented is illustrated in FIG. 2. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary computer system 200 for implementing the invention includes a general purpose computing device in the form of a computer 210. Components of the computer 210 may include, but are not limited to, a processing unit 220, a system memory 230, and a system bus 221 that couples various system components including the system memory 230 to the processing unit 220. The system bus 221 may be any of several types of bus structures including a memory bus or memory controller, a peripheral bus, and a local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnect (PCI) bus also known as the Mezzanine bus.

Computer 210 typically includes a variety of computer readable media. Computer readable media can be any available media that can be accessed by the computer 210 and includes both volatile and nonvolatile media and removable and non-removable media. By way of example, and not limitation, computer readable media may comprise computer storage media and communication media. Computer storage media includes volatile, nonvolatile, removable, and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media, such as acoustic, RF, infrared, and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules, such as phasing model 100, that are immediately accessible to and/or presently being operated on by processing unit 220. By way of example, and not limitation, FIG. 2 illustrates operating system 234, application programs 235, other program modules 236, and program data 237; a phasing model, such as phasing model 100, would operate to order the execution of all software stored or executed from RAM 232.

The computer 210 may also include other removable/non-removable, volatile/nonvolatile computer storage media. By way of example only, FIG. 2 illustrates a computer 210 with a non-removable, non-volatile memory interface 240 that reads from or writes to non-removable, nonvolatile magnetic media 241, such as a hard drive. Computer 210 may also include a non-volatile memory interface 250 that reads from or writes to a device 251, such as a disk drive, that reads from or writes to a removable, non-volatile media 252, such as a magnetic disk. In addition, the computer 210 may include an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules, and other data for the computer 210. For example, hard disk drive 241 is illustrated as storing operating system 244, application programs 245, other program modules 246, and program data 247, which can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through a user input interface 260 connected to user input devices, such as a keyboard 262 and pointing device 261, commonly referred to as a mouse, trackball, or touch pad. Other input devices (not shown) may include a microphone, joystick, game pad, satellite dish, scanner, or the like. These and other input devices are often connected to the processing unit 220 through a user input interface 260 that is coupled to the system bus 221, but may be connected by other interfaces and bus structures, such as a parallel port, game port, or a universal serial bus (USB).

A monitor 291 or other type of display device is also connected to the system bus 221 via an interface, such as a video interface 290. In addition to the monitor 291, the computer 210 may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device, or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks, such as wireless networks. Such networking environments are commonplace in offices, enterprise-wide computer networks, intranets, and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device 281. By way of example, and not limitation, the remote application programs 285 reside on memory device 281. It will be appreciated that the network connections shown are exemplary and other means of establishing a communications link between the computers may be used.

Referring again to FIG. 1, Phase 1 102 is a superphase to sub-phase 1 108 and sub-phase 2 110. Two further sub-phases, sub-phase 2a 112 and sub-phase 2b 114 occur during sub-phase 2 110. Likewise, sub-phase 2 110 is a superphase to sub-phase 2a 112 and sub-phase 2b 114. Any phase or sub-phase may have sub-phases. There is no limit to the number of levels of sub-phases within the multi-tiered phasing model. In addition, there must be at least two phases in any phase space, but there is no limit as to the number of phases above two phases. In addition, if there are sub-phases within a superphase, there must be at least two sub-phases but there is no limit to the number of sub-phases occurring during any superphase above two sub-phases. Any set of sub-phases may be cycled through one or more times during the superphase.

The phase model 100 illustrates a phase space. A phase space is a finite directed graph determining valid phases (graph nodes) and valid phase transitions (graph edges). A phase space therefore determines valid sequences of phases. The phase space 100 is defined over the phase set Phase 1 102, Phase 2 104, and Phase 3 106. The phase space 100 also has three phase transitions 118a, 118b, and 118c. A phase transition represents when the simultaneous change of phase occurs by all software components that share the pre-transition phase.

When software components share a phase space, those software components are part of a phase domain. A phase domain is a set of software components agreeing on a common phasing model as defined by a particular phase space. For example, all software components that agree to be constrained by the master phase space having master phases 102, 104, and 106 are part of the master phase domain. Thus, all software components associated with the software components in the master phase domain include a phase constraint associated with at least one of the master phases 102, 104, and 106.

A phase constraint is a static constraint that limits the phases valid in a certain program context. In particular, constraints can be applied to a program section, asserting that the program section will only execute during a phase honoring the constraint. In one embodiment, phase constraints are written as an attribute in brackets, such as [Phase 1]. This data structure is explained in more detail below.

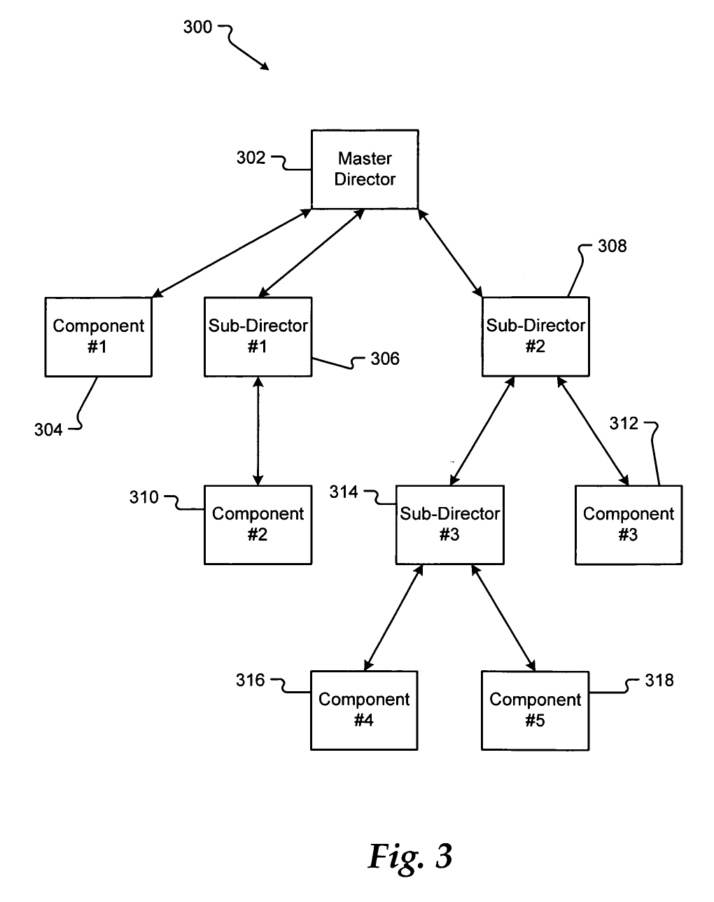

A computer environment 300 having one or more components occupying one or more phase domains is shown in FIG. 3. A master director 302 controls the transitioning and establishment of the master phase space. All components within the computer environment are part of the master phase domain 300 but may occupy one or more sub-phase domains. To enable creation of the phase domain 300, the program author needs to select a phase space, a policy to execute the phase transitions over the phase space, and a policy to handle messages crossing the boundary of the phase domain.

The phase domain 300 can be characterized by a multi-tiered phase space. In embodiments of the present invention, one or more components, such as component 1 304, register with the master director 302. Component 1 304 represents any type of software construct, including software components or methods. The software component 304 is constrained to one of the phases in the master phase space.

In other embodiments, one or more sub-directors, such as sub-director 1 306 and sub-director 2 308, register with the master director 302. The sub-directors control one or more other phase domains with one or more different phase spaces. Thus, the phase domain 300 has one or more nested phase domains. All components, such as component 2 310 registered with sub-director 1 306, are constrained to one or more of the sub-phases within a sub-phase space and within one or more of the master phases of the master phase space. In one embodiment, the sub-phase domain controlled by the sub-director operates within a single master phase. The operations of the sub-phases can occur repeatedly during the single master phase.

In embodiments of the present invention, the sub-directors, such as sub-director 2, register other sub-directors, such as sub-director 3, to create further nested sub-phase domains. In some embodiments, the sub-director 2 308 controls the operation of component 3 312 and the sub-director 3 314. In further embodiments, a director, such as sub-director 3 314, controls more than one component, such as component 4 316 and component 5 318. Each sub-director may control a phase space having unique phases. Thus, sub-director 1 306 operates a first sub-phase space while sub-director 3 314 operates a second sub-phase space. If two phase spaces do not interact, then the phase spaces are called orthogonal spaces. A combination of orthogonal phase spaces can form a Cartesian phase space, which can be used to form the phase domain for a single product. An underlying phase set is the Cartesian product of the orthogonal phase sets, wherein the valid phase transitions are also the Cartesian products of the valid transitions for the orthogonal phase sets.

A director, in embodiments of the present invention, is a logical clock. The director cycles through the phases similar to a clock in a hardware system. At each phase transition, the director simultaneously changes the phase for all software components within the phase domain. In one embodiment, any sub-directors may change the sub-phase in a sub-phase domain at the same time. The logical clock awaits the completion of an operation constrained to the phase or to an operation executing within a sub-phase constrained to the phase.

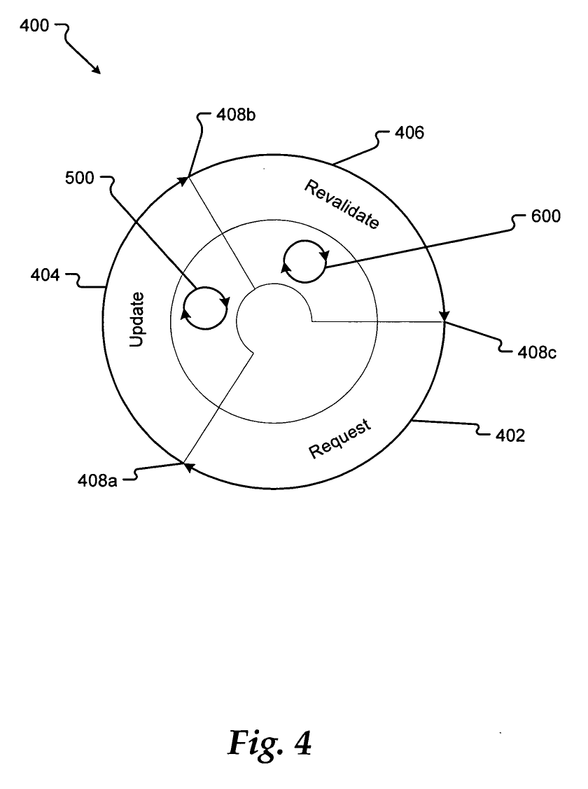

An exemplary embodiment of a phase space 400 that may be used for a master phase domain is shown in FIG. 4. The phase space 400 has three phases. During a read request phase 402, requests for a read or write to data, or other software commands or requests in the software system, are queued until the next phase is entered. In one embodiment, only certain, non-conflicting methods, which are requested, are executed in the next phase, while other methods wait another phase or for the next cycle of the phases

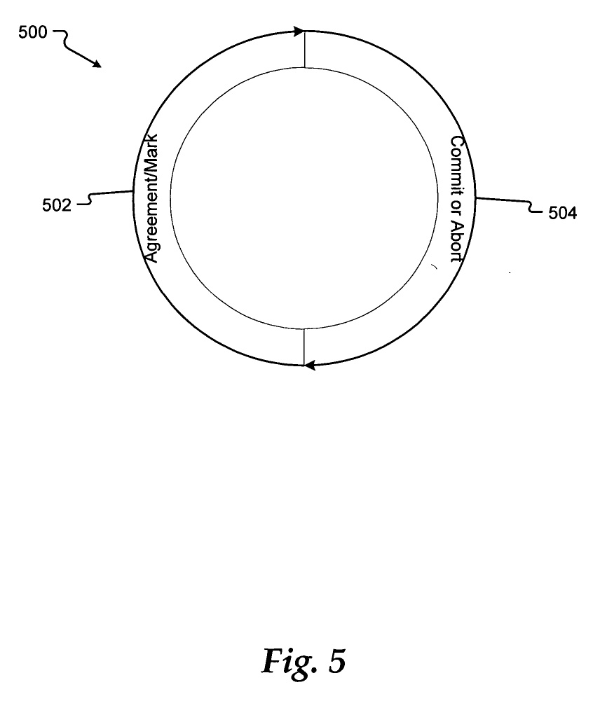

An Update phase 404 directs the commands and requests to the appropriate software component. In embodiments of the present invention, during the Update phase 404, the software components fulfill commands or requests. In one embodiment, the Update phase 404 has a sub-phase space 500 occurring during the Update phase 404. An exemplary sub-phase 500 is shown in FIG. 5 and explained below. In one embodiment, the Update phase 404 triggers sub-phases for data layers. In other words, any requests to write to data are accomplished in the sub-phases of the Update phase 404.

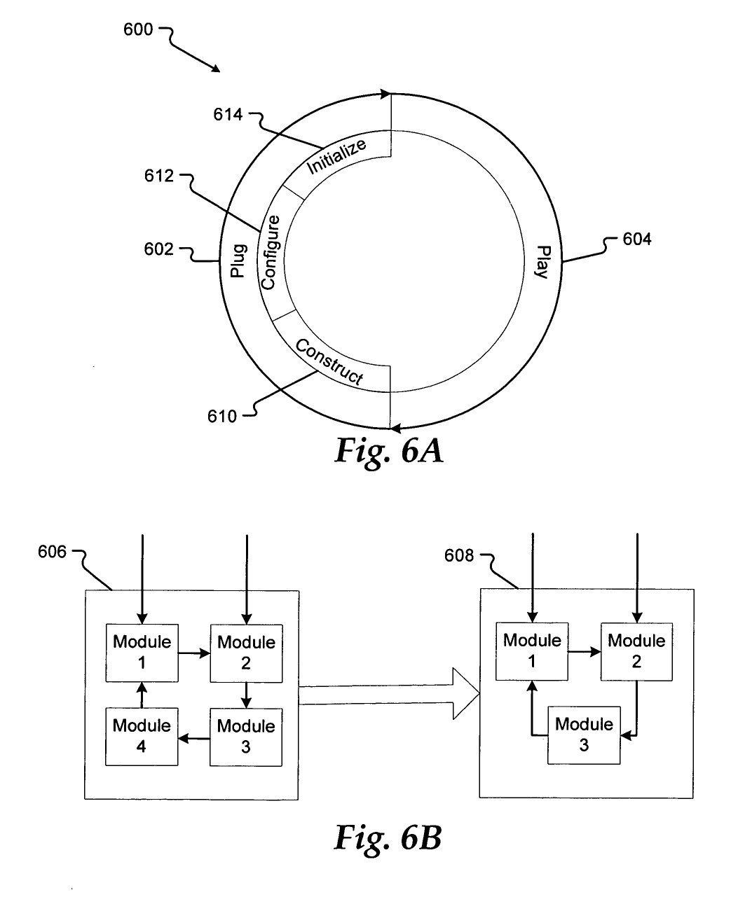

A third phase, the Revalidate phase 406, directs and executes other methods not processed during the Update phase 404. In one embodiment, all requests to retrieve data are completed during the Revalidate phase 406. For example, after data is updated in the Update phase 404, all software components are informed that data changes have occurred, and the informed software components retrieve the updated data. In one embodiment, the Revalidate phase 406 operates a sub-phase space 600. An exemplary embodiment of the sub-phase space 600 is shown in FIG. 6 and described below.

To change phases, the phase space 400 proceeds through a phase transition. In the exemplary embodiment, there are three phase transition 408a, 408b, and 408c representing the transitions between the three phases 402, 404, and 406. As explained above, a phase transition is the point in time at which the director, such as director 302, changes the phase clock, and the phase for all software components in the phase domain changes simultaneously.

Alerting or notifying software components, within the phase domain, of the current phase or the transition to a new phase may occur. In one embodiment, the director notifies all software components of the phase. In other embodiments, a requesting method asks the director for the phase. In embodiments of the present invention, a transition notification is sent to one or more software components within the phase domain. In one embodiment, transition notifications occur either during the current phase or at the beginning of the next phase. In other embodiments, separate phases are employed for the notification process. For example, phase space 400 would have three notifying phases positioned at the transitions 408a, 408b, and 408c that are for notifying software components within the phase domain.

An exemplary sub-phase space 500 of the Update phase 404 is shown in FIG. 5. The sub-phase 500 is, in some embodiments, used for a data layer. In other words, methods for writing data to a shared data structure are constrained to one of the sub-phases of the data sub-phase space 500. In one embodiment, all software components sharing the data agree to either commit the change or abort the change in the Agreement phase 502. The change is either committed or aborted in the Commit or Abort Phase 504.

In another embodiment, both the Agreement phase and the Commit or Abort phase are sub-phases of the “Commit or Abort” sub-phase 504 and sub-phase space 500 has a Mark phase 502 instead of an Agreement sub-phase 502. Here, the data changes are made in the Commit or Abort phase 504, and all software components using the data are marked for update in the Mark phase 502. Marking a software component is setting a flag in the software component that signals the software component to retrieve the updated data in an appropriate later phase. In one embodiment, the marked software components retrieve the data in a Revalidate phase 406. In another embodiment, the Mark phase 502 has two sub-phases: a mark sub-phase and a final mark sub-phase. Here, the software components using the data are marked in the mark sub-phase and retrieve the data in the final mark sub-phase.

Another exemplary sub-phase space 600, occurring during the Revalidate phase 406, is shown in FIG. 6A. An exemplary change in software construction, which is constrained to the sub-phase space 600, is shown in FIG. 6B. The sub-phase space 600 provides sub-phases for plug and play operations. The Plug and Play sub-phase space 600 has two phases: a Play sub-phase 604 and a Plug sub-phase 602. Generally, in a Plug sub-phase 602 the composition and configuration of a software component is established, changed, or removed, but no playtime functionality is performed. Likewise, in a Play sub-phase 604, the established composition or configuration of the software components is used for regular functionality, but no composition or configuration aspects are established, changed, or removed.

An exemplary embodiment of a module reconfiguration is shown in FIG. 6B. In this embodiment, a software module has a first configuration 606. Upon some action, such as a user input request, the software module changes to a second configuration 608. As one skilled in the art will recognize, the software module will operate differently in the first configuration 606 compared to the second configuration 608. Thus, the reconfiguration should occur without methods executed during the play phase interacting with the software module. In embodiments of the present invention, during the Plug sub-phase 602, software instances are initialized, connected or disconnected, and properties set. In some embodiments, further sub-phases help order the operations performed in the Plug sub-phase 602.

In one embodiment, the Plug sub-phase 602 has further sub-phases. A Construct sub-phase 610 creates new software instances by instantiating a known class, calling a software component, or using an interface on an existing instance to acquire a clone or specialized derived instance. A Configure sub-phase 612 adds or removes connections between instances. Finally, an Initialize sub-phase 614 sets properties and requires negotiation between properly connected instances. The sub-phases in the Plug sub-phase 602 may deviate from those presented here. In addition, the Play sub-phase 604 may also contain sub-phases.

Other phasing spaces are contemplated. For example, a sub-phase space for user interface changes is contemplated. In the user interface sub-phase space, an invalidate sub-phase can allow the execution of methods for building structures. A draw sub-phase then draws the built structures. Other phase spaces can be used for other types of operations as one skilled in the art will recognize. In addition, one skilled in the art will recognize that the exemplary phase spaces presented above may be changed as to the number of phases or sub-phases, to the number of tiers or levels, and to the type of phases or sub-phases. As such, the present invention is extensible. In one embodiment, new superphases are overlaid on existing phase spaces. In another embodiment, new phases are added to existing phase spaces. In still other embodiments, more sub-phases or new tiers of sub-phase spaces are added to existing phase spaces.

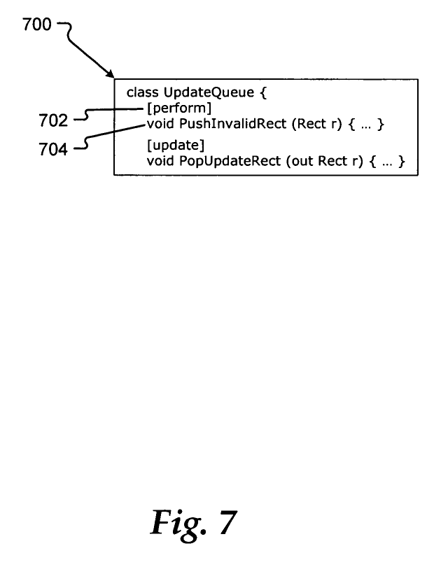

An exemplary embodiment of a data structure 700 having a phase constraint constraining the execution of an item of the code is shown in FIG. 7. The data structure 700 is a code element. Any type of code may have a phase constraint. The phase constraint 702 is shown above a method 704. The phase constraint 702 constrains the operation of the method 704 to the phase specified in the phase constraint, in this embodiment to the phase “Perform.” Thus, the method 704 is only executed during the “Perform” phase or the “Perform” sub-phase.

In embodiments of the present invention, a data structure contains a form of constraint that depends on the software component and the type of operation performed. In one embodiment, the constraint is a call constraint. The call constraint constrains the call of a method to a specified phase. Thus, the execution of methods in other software components or the same software components are constrained by limiting the initiation of those methods only during specified phases. In another embodiment, the constraint is a constructor constraint. A constructor is a special form of method that instantiates software components. Thus, the instantiation of software components is constrained to a specified phase, such as explained with the Construct sub-phase 610 in FIG. 6A. In another embodiment, the constraint is a reference constraint. The reference constraint constrains an entire class of software components and all primitive operations of the class. For example, a reference constraint placed on an interface limits the connections between software modules, such explained with the Connect sub-phase 612 in FIG. 6A.

The constraint is expressed by a phase constraint attribute in the software code that can be assigned to any target software component. In embodiments of the present invention, a phase constraint attribute is assigned to an entire class and is inheritable. Thus, child components inherit constraints from their parent components. In some embodiments, a phasing scheme places multiple phase constraint attributes on the same target. Thus, the software target is constrained by the conjunction of the multiple phase constraints.

Each constraint is a constraint on a “Type” associated with the level of the phase specified. As such, a constraint specifying a superphase is a constraint on “Superphase.” A constraint specifying a sub-phase is a constraint on “Sub-phase.” Constraints on types that are sub-phases are constraints on the union of the all the constraints on the “Super-Types.” The relationships between constraints on types is used by compilers or used at runtime to check for the validity of the constraint relationships amongst different software components.

Enforcing the constraints may occur at runtime or at compile time. At compile time, the constraints on types can be checked. A compiler can check the constraints on Types and constraints on sub-Types against a set of soundness rules for methods with a constraint on a Type calling to methods with a constraint on a sub-Type. A constraint scheme is valid if the constraint on a sub-Type is the same or weaker than the constraint on a Type, for example, if the constraint on a Type specifies the Plug phase 602 and the constraint on a sub-Type specifies the Initialize sub-phase 614. In this embodiment, the Initialize sub-phase constraint 614 executes within the Plug sub-phase 602, and therefore, is a weaker constraint. A constraint scheme is invalid if the constraint on a sub-Type is mutually disjoint with the constraint on a Type, for example, if the constraint on a Type specifies a Play sub-phase 604 and the constraint on a sub-Type specifies the opposed Plug sub-phase 602. A constraint scheme is valid, but must undergo some dynamic checking, if the constraint on a sub-Type is stronger than or overlapping with the constraint on a Type, for example, if the constraint on a Type specifies the Plug sub-phase 602 and the constraint on a sub-Type specifies the Initialize sub-phase 614. In this embodiment, if the phase domain currently operates in both the Plug sub-phase 602 and the Initialize sub-phase 614, the call scheme is valid. However, if the domain is not within one of the two phases, the scheme is invalid. Other soundness rules are contemplated and incorporated into the present invention.

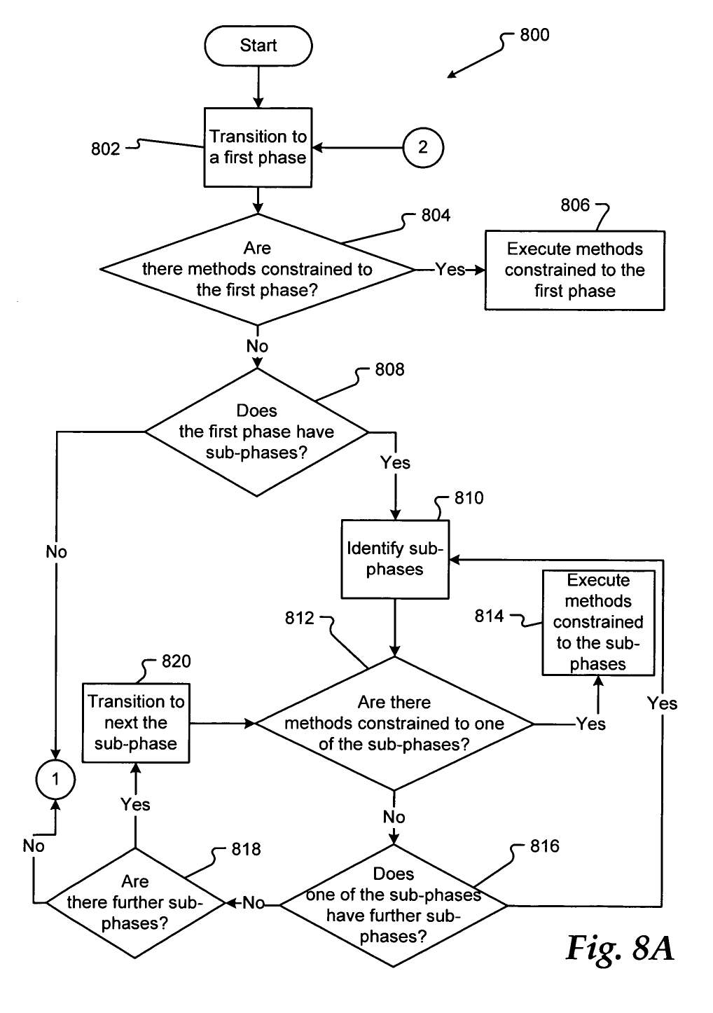

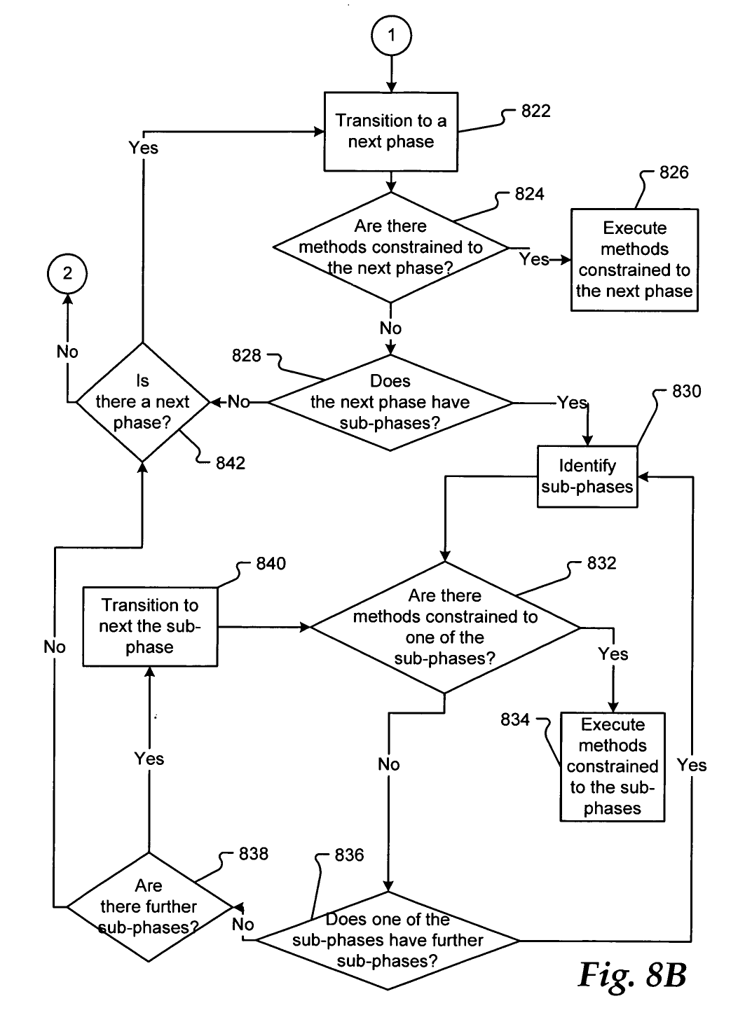

An exemplary embodiment of a method 800 for operating a computer environment within a multi-tiered phasing domain is shown in FIG. 8A and FIG. 8B. After start-up, transition operation 802 transitions into a first phase, such as the Request phase 402. In one embodiment, a master director, such as master director 302, is initiated. In one embodiment, the components, such as component 304, constrained to one of the master phases registers with the master director. The master director begins a phase clock to cycle the logical time through the phases within the phase space, such as phase space 400.

Determine operation 804 determines if any software components, such as component 304, are constrained to the first of the master phases. If a software component is constrained to the first phase, an execute operation 806 executes the software component during the first phase. If there are no software components to execute or during the execution of the software components, determine operation 808 determines if there is a sub-phase space, such as sub-phase space 500, that occurs during the first phase. If there are no sub-phase spaces occurring during the first phase, the process proceeds through connector I to a transition operation 822 shown in FIG. 8B.

If there is a sub-phase space that occurs during the first phase, an identify operation 810 identifies the sub-phase space and the applicable sub-phases. In one embodiment, a sub-director, such as sub-director 306, is initiated and registers with the master director controlling the master phase space. The sub-director begins a sub-phase logical clock to cycle through the sub-phases in the sub-phase space. Determine operation 812 determines if there are any software components, such as component 312, constrained to the current sub-phase. In one embodiment, the software components constrained to the sub-phase space register with the sub-director. Thus, a nested sub-phase domain is created under the master phase domain. If there are software components in the sub-phase domain constrained to the current sub-phase, execute operation 814 executes those software components during the current sub-phase. Determine operation 816 determines if there are further sub-phase spaces, such as sub-phases 610, 612, and 614, that occur within the current sub-phase. If there are further sub-phases, the process returns to identify operation 810 to identify the further sub-phases.

If there are no further sub-phase spaces to identify, determine operation 818 determines if there are any other sub-phases left to occur in the current sub-phase space. If there is another sub-phase to occur in the current sub-phase space, transition operation 820 transitions to the next sub-phase in the sub-phase space. In one embodiment, the sub-director waits until all threads in the current sub-phase are executed and then transitions to the next sub-phase. Then, the process proceeds to the determine operation 812 again. If there are no sub-phases left in the current sub-phase space, then determine operation 818 determines if there is another superphase to transition to in any superphase space. If there is another superphase, transition operation 820 transitions to the next superphase. The process (determining the sub-phases within a superphase; executing software components within the sub-phases; transitioning to the next sub-phase until all sub-phases are complete; and then transitioning to the next superphase) repeats until all sub-phase spaces are cycled through and a transition to a next master phase is required. Once the sub-phase loop ends for the first master phase, the process proceeds through connector I to transition operation 822 shown in FIG. 8B.

Transition operation 822 transitions to a next master phase, such as the Update phase 404. In one embodiment, the master director waits for all threads executing in the first phase to end. Then, the master director changes the logical phase clock to the next phase. In some embodiments, the master director follows the transition rules outlined above with reference to FIG. 3. The process then follows a similar operation as the first phase for identifying sub-phases occurs. As such, some details with regard to the sub-phase process are not described again, but one skilled in the art will recognize how to implement the details described with the first phase into any subsequent processes constrained to a next phase.

Determine operation 824 determines if any software components are constrained to the current master phase. If there are software components constrained to the next master phase, execute operation 826 executes the software components. In embodiments, the software components have already registered with the master director. The software components continue to check with the master director for the current phase. When the phase transitions and the master director reports that the domain is now in the next master phase, the software components, constrained to the next master phase, begin to execute.

If there are no software components constrained to the next master phase or during the execution of the constrained software components, determine operation 828 determines if there are any sub-phase spaces within the current master phase. If there are sub-phase spaces, identify operation 830 identifies the sub-phase space and transitions to a first sub-phase. Determine operation 832 determines if any software components are constrained to the current sub-phase. If there are software components constrained to the current sub-phase, execute operation 834 executes the software components If there are no software components constrained to the current sub-phase or during the execution of those software components, a determine operation 836 determines if there are further sub-phase spaces within the current sub-phase. If there are further sub-phase spaces, the process returns to identify operation 830. If there are no further sub-phase spaces within the current sub-phase, determine operation 838 determines if there is a next sub-phase in the current sub-phase space or a next superphase in the superphase space. If there is a next sub-phase or superphase, transition operation 840 transitions to the next sub-phase or superphase. If there is not a next sub-phase or superphase under the current master phase, then determine operation 842 determines if there is a next master phase, such as the Revalidate phase 406. If there is a next master phase, the process returns to the transition operation 822. If there is not another master phase in the master phase space, the process returns through connector 2 to the transition operation 802 and starts the phase cycle over by transitioning to the first phase.

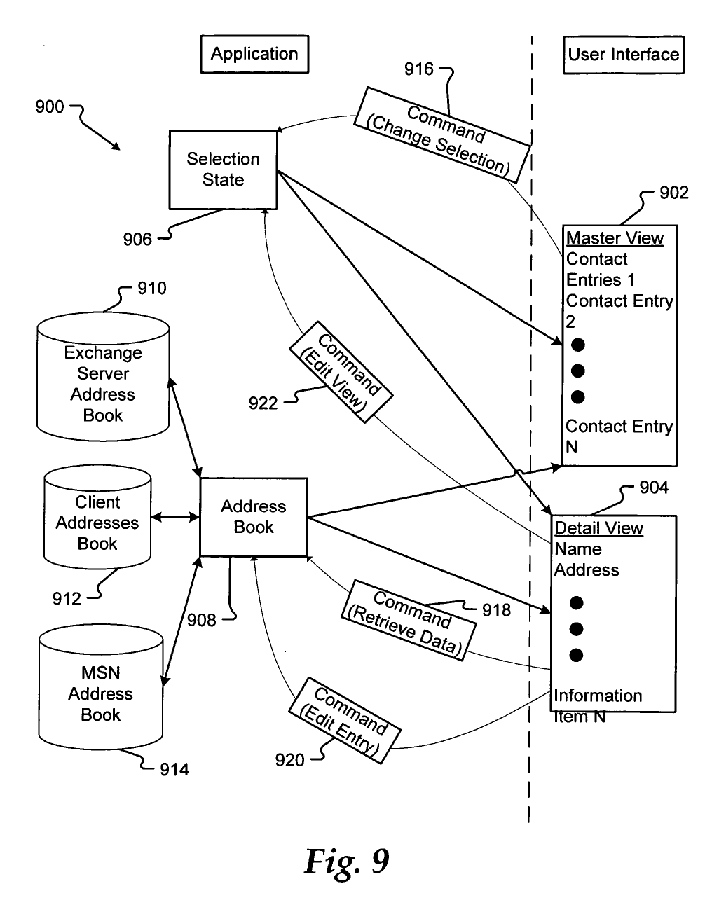

To further explain the present invention, an exemplary computer system operating within a multi-tiered phasing domain is described below with reference to FIG. 9. The exemplary computer system operates a personal contacts application, such the Microsoft® Outlook® messaging and collaboration client program. Here, a user interface displays one or more contacts in an address book. The user interface has a master view window 902. The master view 902 shows all contacts and allows a user to select a contact to view more detailed information about the contact.

The computer environment 900 operates under a phase space. For purposes of explanation and not limitation, the entire system 900 operates under the phase space 400 shown in FIG. 4. In addition, for explanation purposes, the computer system 900 is currently in a Request phase 402. As such, the computer system 900 allows any operation where a request or command is received. Thus, a user command 916 to view a detailed view 904 of a contact is received and placed in a queue. In addition, a command 918 is sent to the address book module 908 to retrieve the detailed information requested. The data request 918 is also queued.

A master director 302 changes the phase in the computer system domain 900 to an Update phase 404. Here, the commands 916 and 918 are sent to the Selection State module 906 and the Address book 908, respectively. A user interface sub-phase space for changes to the user interface, as explained above with reference to FIG. 6, is transitioned into during the Update phase 404. An invalidate sub-phase begins. The command 916 for the detailed view 904 begins processing. Views in the master view 902 are invalidated. For example, the selection for the detailed view 904 is set to inactive. In addition, the master view 902 is set to the inactive window. A detailed view 904 is created with the appropriate fields and user interface items. The user interface sub-director then transitions to a draw sub-phase. The selection in the master view 902 for the contact is drawn to appear inactive, e.g., the highlighted selection changes color. The master view 902 is drawn as inactive. For example, the master view 902 windowpane changes color to signify that it is inactive. The detailed view 904 is drawn with the user interface elements. Fields are left open to receive the data from the address book module 908.

A master director 302 transitions to the Revalidate phase 406 after all the invalidating and drawing constrained operations have been completed in the user interface sub-phase space. A data retrieve operation is executed during the Revalidation phase 406. The data retrieve operation, in one embodiment, is constrained to a data retrieve sub-phase space. The data retrieve sub-phase space has two sub-phases, mark and final mark, as explained with reference to FIG. 6. The mark sub-phase is initiated. The address book searches for software modules that require the update of data. The detailed view 904 is marked. A sub-director for the data retrieve sub-phase space transitions to a final mark sub-phase. In the final mark sub-phase, the address book 908 retrieves the required contact information from one of three data stores: an exchange server address book 910, a client address book 912, or an MSN address book. Upon retrieving the contact information, the address book 908 writes the contact information into the detail view 904.

Upon completing all operations constrained to the Revalidate phase 406, the master director 302 transitions back to the Request phase 402. Here, the user interface again accepts commands and requests from the user input devices. A user inputs a change to the contact information within the detailed view 904. For example, the user changes the address of a contact. A command 920 is sent from the detailed view 904 to the address book 904 to change the data. In addition, a command 922 is sent to the selection state 906 to update the views of the master view 902 and the detailed view 904. In this embodiment, the commands would be queued, and the master director 302 would transition to an Update phase 404. The Update phase 404 initiates a data write sub-phase space, such as the sub-phase space 500.

In an Agreement sub-phase 502, the address book sends a data change request to the several data stores 910, 912, and 914. One or more of the data stores may contain a copy of the data changed in the detailed view 904. Thus, each data store that has the data must agree to change the data. Thus, a voting procedure occurs during the Agreement sub-phase 502. If all data stores agree to commit the change, the agreement is sent back to the address book 908. The sub-director changes the phase to the Commit or Abort phase 504. Here, the data change is sent to the data stores and is used to update the data.

Meanwhile, during the Update phase 404, a user interface sub-phase space occurs. The selection state 906 invalidates sections of the master view 902 and the detailed view 904 containing old data during an invalidate sub-phase. In a draw sub-phase, the master view 902 and the detailed view 904 are redrawn holding spaces for the changed data. Upon all sub-phases completing in the Update phase 404, the phase domain 900 transitions to a Revalidate phase 406.

In the Revalidate phase 406, further sub-phase spaces include sub-phases for Mark and Final Mark. Transitioning into the Mark phase, the address book 908 marks the master view 902 and the detailed view 904 as requiring the changed data. In the Final Mark sub-phase, the changed data is written into the master view 902 and the detailed view 904. These changes can occur in a very short amount of time and in a fine granularity. For instance, the phases are cycled after every character entered by the user and in minute fractions of a second. Thus, the changes would appear to happen instantaneously.

The present example demonstrates how multi-tiered phasing constrains the execution of methods within a system. If the commands and the changes happened without phasing, it is possible that the master view 902 and the detailed view 904 may be updated before all the data store have changed the data. Therefore, the user may view mixed results in the detailed view 904 or the master view 902 depending on the order of the methods attempting to change the data and to update the user interface views.

Although the present invention has been described in language specific to structural features, methodological acts, and computer readable media containing such acts, it is to be understood that the present invention defined in the appended claims is not necessarily limited to the specific structure, acts, or media described. One skilled in the art will recognize other embodiments or improvements that are within the scope and spirit of the present invention. Therefore, the specific structure, acts, or media are disclosed as exemplary embodiments of implementing the claimed invention. The invention is defined by the appended claims.

What is claimed is:

1. A computer program product encoding a computer program of instructions for a computer system having components, the components comprising:
a plurality of software components forming two or more sets of software components;
a first set of software components constrained to a first phase domain characterized by a first phase space; and
a second set of software components constrained to a second phase domain characterized by a second phase space.

2. The computer program product of claim 1, wherein the first phase space is a master phase space.

3. The computer program product of claim 1, wherein the second phase domain is a sub-phase domain of the first phase domain and is characterized by a sub-phase space.

4. The computer program product of claim 3, wherein the sub-phase domain further comprises one or more further sub-phase domains characterized by one or more further sub-phase spaces.

5. The computer program product of claim 1, wherein the first phase domain and the second phase domain are orthogonal.

6. The computer program product of claim 1, further comprising a master director controlling the first phase domain.

7. The computer program product of claim 6, further comprising
one or more sub-directors controlling one or more sub-phase spaces under the first phase domain; and
one or more software components registered with one of the sub-directors that constrains the execution of the one or more software components to one or more of the sub-phases controlled by the sub-director.

8. The computer program product of claim 6, further comprising one or more software components registered with the master director that constrains the execution of the one or more software components to one or more of the phases controlled by the master director.

9. The computer program product of claim 6, wherein the one or more sub-directors are registered with the master director and are controlled by the master director.

10. The computer program product of claim 1, wherein the completion of all methods constrained to the first phase and completion of all methods constrained to the second phase results in the completion of a computer operation.

11. A computer program product encoding a computer program of instructions for executing a computer implemented method for structuring the execution of a plurality of methods within a software system, the method comprising:
transitioning to a first phase;
constraining the execution of a first method to the first phase;
transitioning to one or more other phases; and
constraining the execution of one or more other methods to the one or more other phases.

12. The computer program product of claim 11, wherein the first phase is one of a request phase, an update phase, or a revalidate phase.

13. The computer program product of claim 11, wherein the first phase has two or more sub-phases.

14. The computer program product of claim 13, wherein the two or more other sub-phases comprise an agreement sub-phase and a commit or abort sub-phase.

15. The computer program product of claim 13, wherein the two or more sub-phases comprises a mark sub-phase and a final mark sub-phase.

16. The computer program product of claim 13, wherein the two or more sub-phases comprise a plug sub-phase and a play sub-phase.

17. The computer program product of claim 16, wherein the plug sub-phase further comprises a construct sub-phase, a configure sub-phase, and an initialize sub-phase.

18. The computer program product of claim 11, wherein the first method is constrained to the first phase by a phase constraint attribute in the method.

19. A computer program product having stored thereon a data structure, comprising a data field containing a phase constraint attribute that limits operations associated with the data structure to a phase specified.

20. The computer program product of claim 19, wherein the phase constraint attribute comprises one of a call constraint, a constructor constraint, or a reference constraint.
